(19) United States
(12) Patent Application Publication
(10) Pub. No.: US 2026/0004701 A1
(43) Pub. Date: Jan. 1, 2026

(54) MODE TRANSITION ON A DUAL-RESOLUTION DISPLAY

(71) Applicant: DELL PRODUCTS L.P., Round Rock, TX (US)

(72) Inventors: Hyunseok Ko, Singapore (SG); Seungjae Sung, Singapore (SG)

(21) Appl. No.: 18/757,055

(22) Filed: Jun. 27, 2024

(51) Int. Cl. G09G 3/20

(52) U.S. Cl. CPC G09G 3/2096; G09G 2340/0435; G09G 2360/18

(57) ABSTRACT

A display device that includes a display panel, a frame buffer, and a timing controller. The timing controller is configured to store data associated with an image to the frame buffer in response to detecting a signal to switch to a display mode and read the data associated with the image from the frame buffer after the signal is detected. The timing controller is further configured to provide the data associated with the image to the display panel and maintain the image in the display panel until a transition to the display mode is complete. In addition, the timing controller is configured to update the image in the display panel with another image from video data associated with the display mode.

### FIELD OF THE DISCLOSURE

The present disclosure generally relates to information handling systems, and more particularly relates to mode transition on a dual-resolution display.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A display device that includes a display panel, a frame buffer, and a timing controller. The timing controller is configured to store data associated with an image to the frame buffer in response to detecting a signal to switch to a display mode and read the data associated with the image from the frame buffer after the signal is detected. The timing controller is further configured to provide the data associated with the image to the display panel and maintain the image in the display panel until a transition to the display mode is complete. In addition, the timing controller is configured to update the image in the display panel with another image from video data associated with the display mode.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system, according to an embodiment of the present disclosure;

FIG. 2 is a timing diagram for a mode transition on a dual-resolution display, according to an embodiment of the present disclosure;

FIG. 3 is a flowchart of a method for a mode transition on a dual-resolution display, according to an embodiment of the present disclosure; and

FIG. 4 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Display devices with a feature to change its display mode which includes a change in its resolution and/or frequency, also referred to as a refresh rate. A display device can transition into a display mode, also referred to simply as mode, with a reduced resolution and increased refresh rate from its native resolution and frequency. The display device can also transition to a mode with increased resolution and decreased refresh rate. For example, the display device can transition from ultra-high definition (UHD) with a refresh rate of 240 Hz to full high definition (FHD) with a refresh rate of 480 Hz or vice versa. Accordingly, a user can choose either mode based on various factors, such as application, game genre, etc. However, transitioning to a different mode typically restarts the display monitor which causes a momentary interruption. This causes the display device to display a black screen during the mode transition which causes and interruption to a user's experience. To address this issue among others, the present disclosure provides a system and method for a seamless mode transition on dual-resolution display devices.

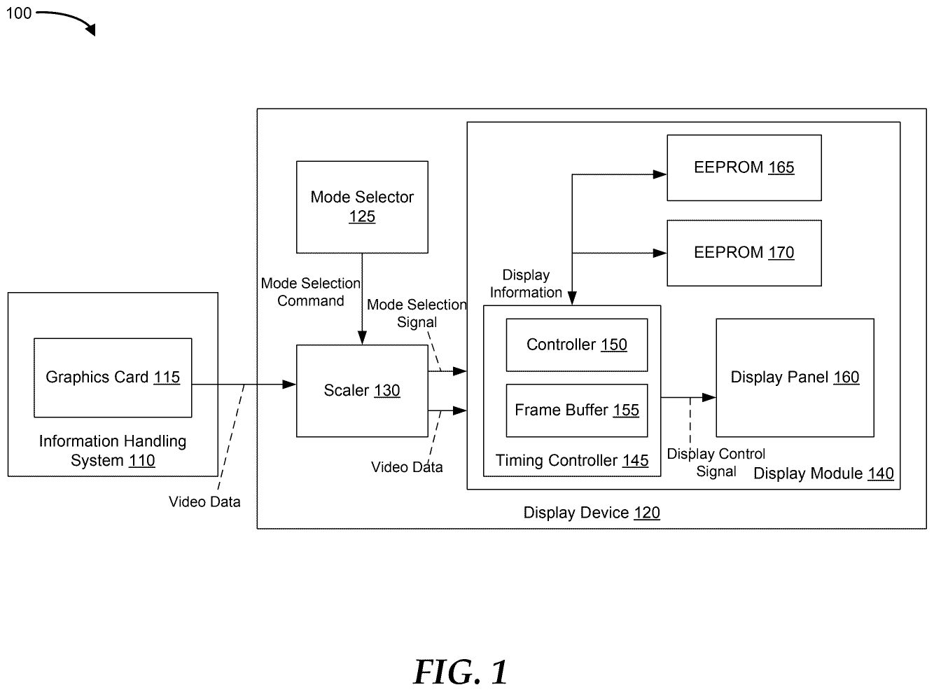

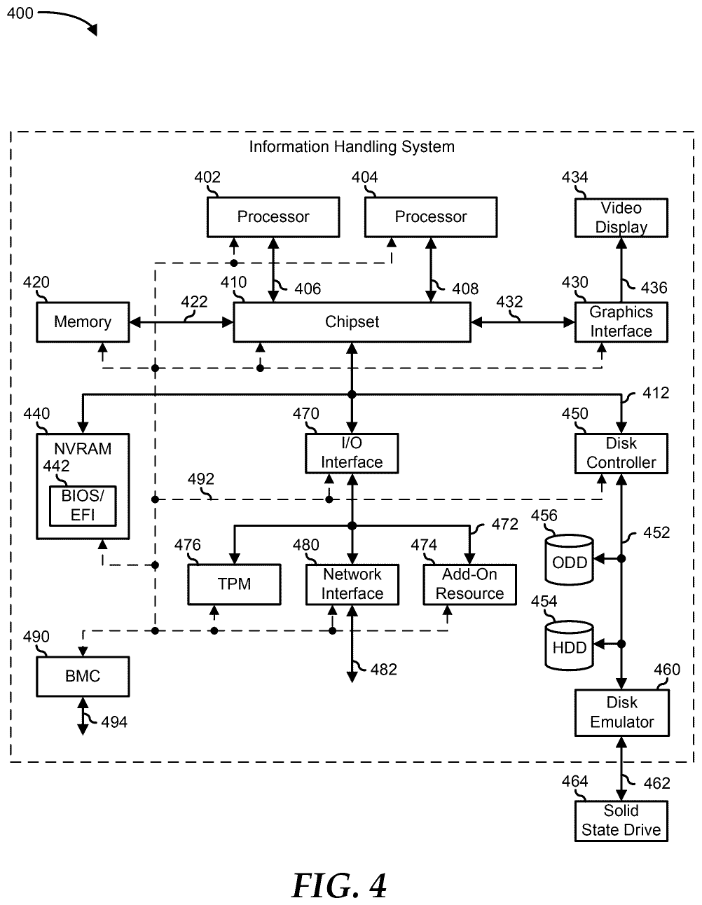

FIG. 1 shows a portion of a system 100, according to an embodiment of the present disclosure. System 100 includes an information handling system 110 and a display device 120. Information handling system 110, which is similar to information handling system 400 of FIG. 4, includes a graphics card 115. Display device 120 includes a mode selector 125, a scaler 130, and a display module 140. Display module 140 includes a timing controller 145, a display panel 160, an electronically erasable programmable read-only memory (EEPROM) 165, and an EEPROM 170. Timing controller 145 includes a controller 150 and a frame buffer 155.

Information handling system 110 may be communicatively coupled to display device 120. In particular, graphics card 115 is communicatively coupled to scaler 130. In addition, mode selector 125 may also be communicatively coupled to scaler 130. Scaler 130 may be communicatively coupled to display module 140. Each of EEPROMs 165 and 170 may be communicatively coupled to timing controller 145 via an interface such as an inter-integrated circuit (1²C) interface, an improved I2C (I³C) interface, or similar. Timing controller 145 may be communicatively coupled to display panel 160. However, any variety of connections between components of system 100 is envisioned as falling within the scope of the present disclosure. In addition, connections between components may be omitted for descriptive clarity.

Graphics card 115, which is similar to graphics adapter 430 of FIG. 4, may be configured to provide graphics or video data to display device 120 via a connection interface, such as a DisplayPort™, High-Definition Multimedia Interface (HDMI), Digital Video Interface (DVI), etc. In this example, graphics card 115 is installed in information handling system 110 which can be a source of the graphics or video data. In another example, the source can include any of a variety of video processing components configured to generate image content for display, including, but not limited to a digital signal processor, a television tuner, a video decoder, and the like. The video data may include pixels for one or more video frames for display.

Display device 120, which is similar to video display 434 of FIG. 4, is configured to receive video data from a source, such as information handling system 110, a digital video disc player, etc. Display device 120 may be configured to display information, graphics, and/or the video data received from information handling system 110 or other sources. Display device 120 may utilize liquid crystal display (LCD), light emitting diode (LED), organic LED (OLED), or other display technologies. Display device 120 may be integrated into information handling system 400, such as a display device integrated into a laptop, tablet, 2-in-1, convertible device, or mobile device. Display device 120 may also be an external display, such as a display monitor, television, etc. Display device 120 may be capable of different display formats, such as high-definition (HD), FHD, UHD, high-dynamic range (HDR), etc. Each display format may be associated with different frame rates. For example, the video data being rendered in the HDR display format may have a frame rate of 60 Hz.

Display panel 160 may be a surface where the video data is displayed. For LCD devices, display panel 160 may be a packaging of liquid crystals embedded between two glass substrates while display module 140 includes a backlight unit. For OLED devices, display panel 160 may include a substrate, backplane, and frontplane. However, OLED devices do not include backlight units.

Mode selector 125 may comprise any system, device, or apparatus operable to allow a user to switch from one display mode to another display mode. For example, mode selector 125 may allow the user to switch from a first mode in UHD at 240 Hz and a second mode in FHD at 480 Hz. The selected mode may be transmitted to scaler 130 via a mode selection command. In one embodiment, mode selector 125 may be a hardware device, such as a physical switch, a multiplexer, or similar. In another embodiment, mode selector 125 may be an application or software such as an on-screen display menu configured to allow the user to select between two or more display modes.

Scaler 130 may be implemented in hardware, such as a chip or semiconductor integrated circuit, in software, such as a set of executable program instructions stored in a display controller memory, or a combination of both hardware and software. Scaler 130 may be configured to perform one or more video support functions. For example, scaler 130 may be configured to receive the mode selection command from mode selector 125. The mode selection command may be a binary value corresponding to a display mode. For example, the mode selection command for FHD at 480 Hz is: 0000_0000 while the mode selection command for UHD at 240 Hz is 0000_0010. However, the mode selection command may be in other formats, such as a hexadecimal value.

Scaler 130 may convert the mode selection command into a mode selection signal, which is an analog signal. For example, scaler 130 may include a digital-to-analog converter that converts the binary value or the hexadecimal value to a corresponding analog signal. Scaler 130 then may transmit the mode selection signal to timing controller 145. The mode selection signal may be a low voltage for UHD at 240 Hz and a high voltage for FHD at 480 Hz. For example, zero to one volt may be used to indicate UHD at 240 Hz and 2.3 to 3.3. volts to indicate FHD at 480 Hz. In addition, scaler 130 may be configured to transmit the video data received from graphics card 115 to timing controller 145.

Timing controller 145 may comprise any system, device, or apparatus operable to control operations of various components, such as a backlight of display module 140, and provide an image to display panel 160. In one example, timing controller 145 may be implemented in hardware, such as a chip or semiconductor integrated circuit, in software, such as a set of executable program instructions stored in a display controller memory, or a combination of both hardware and software. In particular, timing controller 145 may be configured to translate the video data into pixel data prior to transmission to display panel 160. In addition, timing controller 145 may read display information from one of the EEPROMs and load parameters associated with the resolution and/or refresh rate, among others.

Each one of EEPROMs 165 and 170 comprise any system, device, or apparatus operable to store information associated with a display mode. In one embodiment, EEPROMs 165 and 170 may be part of an integrated circuit. In particular, the EEPROMs may store parameters to drive display panel 160 at a particular display resolution and frequency. For example, EEPROM 165 may store display information for displaying video data at a first display mode, wherein the first display mode may be a UHD display format at 240 Hz. EEPROM 170 may store display information for displaying video data at a second display mode, wherein the second display mode may be an FHD display format at 480 Hz.

Accordingly, if the mode selection signal received indicates a display resolution of UHD at 240 Hz refresh rate, then timing controller 145 may read the display information from EEPROM 165. In another example, if the mode selection signal received indicates a display resolution of FHD at 480 Hz refresh rate, then timing controller 145 may read the display information from EEPROM 170.

Based on the display information read from one of the EEPROMs, timing controller 145 may provide a display control signal to display panel 160. The display control signal may indicate the display format and frequency, wherein each display format and frequency may be associated with a particular display control signal similar to the mode control signal. For example, a first display signal may be associated with a first display format and frequency while a second display signal may be associated with a second display format and frequency. In addition, timing controller 145 may be configured to provide a frame or image of the video data to display panel 160. Further, timing controller 145 may be configured to provide the last known image or frame stored in frame buffer 155 to display panel 160 during a display mode transition until the transition is finished or complete to avoid a black screen.

Controller 150 may comprise any system, device, or apparatus operable to store and/or retrieve a last known frame of the video data from frame buffer 155 via an interface, such as a Stub Series Terminated Logic (SSTL) interface. The last known frame may be at a current display mode which may be displayed at display panel 160 during a transition from the current display mode to a next display mode. The last known frame of the video data may also be a current frame of the video data being displayed. Frame buffer 155 includes a random access memory that is used to store the last known frame. Frame buffer 155 can be embedded within the same package of timing controller 145 or the same die.

Those of ordinary skill in the art will appreciate that the configuration, hardware, and/or software components of system 100 may vary. For example, the illustrative components within system 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

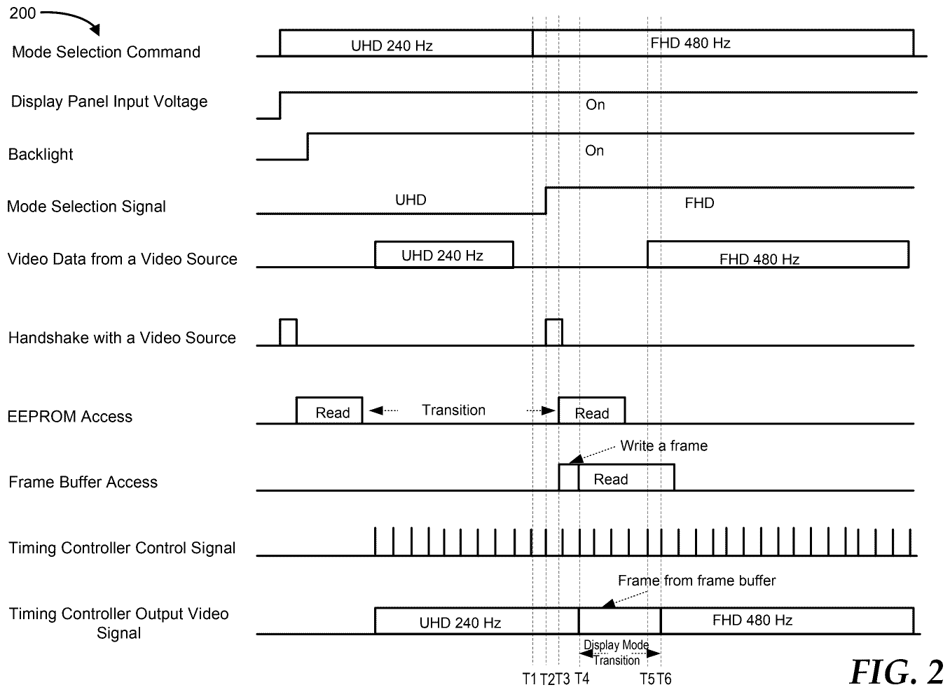

FIG. 2 shows a timing diagram 200 for a system similar to system 100 of FIG. 1, according to an embodiment of the present disclosure. Here, power is provided to a display device via a display panel input voltage. After providing the power to the display device, the backlight is powered on. The power may be provided before or at the same time a first mode selection command for a first display mode associated with UHD at 240 Hz is transmitted to a scaler in response to a selection of the first display mode by a user. The user may select the display mode using a hardware or software switch, such as via an on-screen display menu. The selection may be performed manually or automatically, such as by an application associated with the video for display. The first display mode may be a default display mode of the display device.

After receipt of the mode selection command, the scaler may perform a handshake with a source of video data and transmit a mode selection signal to a timing controller. The mode selection signal may indicate the selection of the first display mode. After receipt of the mode selection signal, the timing controller may access an EEPROM associated with the first display mode to read display information, such as display resolution and frequency associated with the first display mode. At this point, the timing controller may receive a first video data associated with the first display mode from the source. In addition, the timing controller may start generating control signals for gate and source drivers of a display panel. Further, the timing controller may also provide an output video signal to the display panel to render the first video data using the first display mode.

At T1, a second mode selection command may be transmitted to the scaler in response to a selection of a second display mode by the user. At T2, the scaler may transmit a second mode selection signal to the timing controller in response to receiving the second mode selection command. In addition, the scaler may perform another handshake with the video source. The handshake may include a link retraining associated with the second display mode.

At T3, the timing controller may store a last known image or frame of the first video data associated with the first display mode to a frame buffer in response to receiving the second mode selection signal. In addition, the timing controller may access a second EEPROM to read display information associated with the second display mode. In this example, the period of transition between the access to a first EEPROM and the access to the second EEPROM may be shorter than typical because initiating a transition to the second display mode does not require a power restart, such as via another assertion of display panel input voltage. At the same time, the timing controller may continue transmitting the control signals and outputting video signals associated with the first video data. Further, the scaler may perform a handshake with the display module for the transition to the second display mode.

At T4, the timing controller may read the frame stored in the frame buffer and transmit an output video signal associated with the frame to the display panel for rendering. The timing controller may maintain the last frame while it continues reading the display information associated with the second display mode from the second EEPROM. In addition, the timing controller may also continue with the handshake with the scaler, transmission of the control signals, and providing output video signal to the display panel associated with the first video data.

At T5, the scaler and/or the timing controller may receive a second video data associated with the second display mode from the video source. However, the timing controller may continue to provide the output video signal associated with the frame or image from the frame buffer until it is ready to provide an output video signal associated with the second video data at T6. During the display mode transition between T4 and T6, the timing controller may continue with the transmission of the control signal and output video signal. Accordingly, there is no break or latency between the transition from displaying the first video data associated with the first display mode to displaying the second video data associated with the second display mode.

One of skill in the art will appreciate that this timing diagram explains a typical example, which can be extended to applications or services in practice. It will be readily appreciated that not every process set forth in this flow diagram is always necessary and that certain steps of the methods may be combined, performed simultaneously, in a different order, or perhaps omitted, without varying from the scope of the disclosure. For example, although a handshake is performed to train the receiver for the display resolution and refresh rate associated with the video data for certain interfaces, such as Embedded DisplayPort (eDP), V-by-One® (Vx1), the handshake is optional for certain interfaces, such as low-voltage differential signaling (LVDS) interface, etc. In addition, although examples depicted herein show two display resolutions, one of skill in the art will appreciate that the system and method can be extended to display devices that support more than two display resolutions and refresh rates.

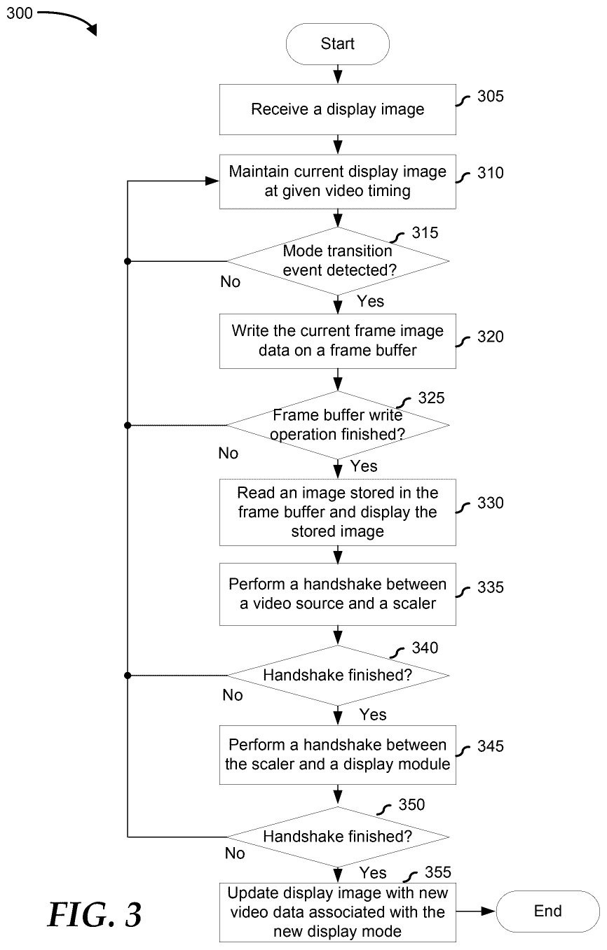

FIG. 3 shows a flowchart for a method 300 for mode transition on a dual-resolution display, according to an embodiment of the present disclosure. Method 300 may be performed by any suitable component of system 100 including, but not limited to, mode selector 125, scaler 130, timing controller 145, display panel 160, EEPROM 165, and EEPROM 170 of FIG. 1. While embodiments of the present disclosure are described in terms of the components of system 100 of FIG. 1, it should be recognized that other components may be utilized to perform the described method. One of skill in the art will appreciate that this flowchart explains a typical example, which can be extended to applications or services in practice. It will be readily appreciated that not every method step set forth in this flow diagram is always necessary and that certain steps of the methods may be combined, performed simultaneously, in a different order, or perhaps omitted, without varying from the scope of the disclosure.

Method 300 typically starts at block 305 where a display device, or a scaler in particular, receives video data that includes an image from a graphics card. The video data includes video and other information for displaying the image at a current display mode, the image may be referred herein as a current image. The scaler may transmit the current image to a timing controller. The method proceeds to block 310, where the display device, or in particular, the timing controller may maintain or render the current image at a display panel of the display device at the current display mode. For example, the timing controller may maintain the current image at a current mode of UHD at 240 Hz.

In one embodiment, at decision block 315, the scaler may determine whether a display mode transition event is detected, such as from a current display mode to a new display mode. The display mode transition event is detected by the scaler when it receives a mode selection command from a mode selector. The mode selection command may indicate the new display mode. The scaler may convert the mode selection command to a mode selection signal and transmit the mode selection signal to the timing controller. The mode selection signal may also indicate the new display mode. In another embodiment, the timing controller may determine whether the display mode transition event is detected. The display mode transition event is detected by the timing controller when it receives the mode selection signal from the scaler. If a display mode transition event is detected, then the “YES” branch is taken, and the method proceeds to block 320. If a display mode transition event is not detected, then the “NO” branch is taken, and the method proceeds to block 310.

At block 320, the timing controller may write the current image and associated data on a frame buffer. The current image may also be referred to as a last known image of the video data. The method proceeds to decision block 325, where the timing controller may determine whether the frame buffer write operation is finished. If the wrote operation to frame buffer is finished, then the “YES” branch is taken, and the method proceeds to block 330. If the frame buffer write operation is not finished, then the “NO” branch is taken, and the method proceeds to block 310. At block 330, the timing controller may read the image stored in the frame buffer and update the current image being displayed at a display panel with the stored image. Because the current image may be similar to the stored image, a user may not notice a difference between the displayed images and thus not cause an interruption with the user's experience.

The method proceeds to block 335, where the scaler may perform a handshake with the graphics controller to communicate the new display mode. In this handshake, the scaler may act as the receiver while the graphics controller may act as a transmitter. During the handshake, which includes link training, the scaler and the graphics controller may communicate to determine the capability of the scaler, such as its supported maximum display resolution, bandwidth, number of lanes, minimum and maximum frequency, and so on. The communication may also utilize an extended display identification (EDID) data exchange, wherein the scaler may communicate its capabilities to the graphics controller. For example, the EDID may include information on the supported capabilities of the scaler, such as its maximum display resolution, minimum and maximum frequency, different interface timings, luminance value, color coordinates, and so on.

The method may proceed to decision block 340, where the scaler and/or the graphics controller may determine whether the handshake is finished. For example, the scaler may read a value of a status parameter. If the handshake is finished, then the “YES” branch is taken, and the method proceeds to block 345. If the handshake is not finished, then the “NO branch is taken, and the method proceeds to block 310.

At block 345, the scaler may perform a handshake with a display module to communicate the new display mode. The handshake may be similar to the handshake performed at block 335 except that in this handshake, the scaler may act as the transmitter while the display module may act as the receiver. Accordingly, during the handshake which includes link training, the scaler and the display module may communicate to determine the capability of the display module, such as its supported maximum display resolution, bandwidth, number of lanes, minimum and maximum frequency, and so on. The communication may also utilize an extended display identification (EDID) data exchange, wherein the display module may communicate its capabilities to the scaler. For example, the EDID may include information on the supported capabilities of the display module, such as its maximum display resolution, minimum and maximum frequency, different interface timings, luminance value, color coordinates, and so on.

The method may proceed to decision block 350, the scaler and/or the display module may determine whether the handshake is finished. For example, the scaler may read a value of a status parameter. If the handshake is finished, then the “YES” branch is taken, and the method proceeds to block 355. If the handshake is not finished, then the “NO branch is taken, and the method proceeds to block 310. At block 355, the timing controller may update the stored image being displayed with a new image of the video data received that is associated with the new display mode. Thus, there is no interruption of an image displayed on the display panel for the user. Afterwards, the method ends.

FIG. 4 illustrates an embodiment of an information handling system 400 including processors 402 and 404, a chipset 410, a memory 420, a graphics adapter 430 connected to a video display 434, a non-volatile RAM (NVRAM) 440 that includes a basic input and output system/extensible firmware interface (BIOS/EFI) module 442, a disk controller 450, a hard disk drive (HDD) 454, an optical disk drive 456, a disk emulator 460 connected to a solid-state drive (SSD) 464, an input/output (I/O) interface 470 connected to an add-on resource 474 and a trusted platform module (TPM) 476, a network interface 480, and a baseboard management controller (BMC) 490. Processor 402 is connected to chipset 410 via processor interface 406, and processor 404 is connected to the chipset via processor interface 408. In a particular embodiment, processors 402 and 404 are connected together via a high-capacity coherent fabric, such as a HyperTransport link, a QuickPath Interconnect, or the like. Chipset 410 represents an integrated circuit or group of integrated circuits that manage the data flow between processors 402 and 404 and the other elements of information handling system 400. In a particular embodiment, chipset 410 represents a pair of integrated circuits, such as a northbridge component and a southbridge component. In another embodiment, some or all of the functions and features of chipset 410 are integrated with one or more of processors 402 and 404.

Memory 420 is connected to chipset 410 via a memory interface 422. An example of memory interface 422 includes a Double Data Rate (DDR) memory channel and memory 420 represents one or more DDR Dual In-Line Memory Modules (DIMMs). In a particular embodiment, memory interface 422 represents two or more DDR channels. In another embodiment, one or more of processors 402 and 404 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 420 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 430 is connected to chipset 410 via a graphics interface 432 and provides a video display output 436 to a video display 434. An example of a graphics interface 432 includes a Peripheral Component Interconnect-Express (PCIe) interface and graphics adapter 430 can include a four-lane (×4) PCIe adapter, an eight-lane (×8) PCIe adapter, a 16-lane (×16) PCIe adapter, or another configuration, as needed or desired. In a particular embodiment, graphics adapter 430 is provided down on a system printed circuit board (PCB). Video display output 436 can include a DVI, an HDMI, a DisplayPort interface, or the like, and video display 434 can include a monitor, a smart television, an embedded display such as a laptop computer display, or the like.

NVRAM 440, disk controller 450, and I/O interface 470 are connected to chipset 410 via an I/O channel 412. An example of I/O channel 412 includes one or more point-to-point PCIe links between chipset 410 and each of NVRAM 440, disk controller 450, and I/O interface 470. Chipset 410 can also include one or more other I/O interfaces, including a PCIe interface, an Industry Standard Architecture (ISA) interface, a Small Computer Serial Interface (SCSI) interface, an I²C interface, a System Packet Interface, a Universal Serial Bus (USB), another interface, or a combination thereof. NVRAM 440 includes BIOS/EFI module 442 that stores machine-executable code (BIOS/EFI code) that operates to detect the resources of information handling system 400, to provide drivers for the resources, to initialize the resources, and to provide common access mechanisms for the resources. The functions and features of BIOS/EFI module 442 will be further described below.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an institute of electrical and electronics engineers (IEEE) 1394 (Firewire) interface, a proprietary interface, or a combination thereof. Alternatively, SSD 464 can be disposed within information handling system 400.

I/O interface 470 includes a peripheral interface 472 that connects the I/O interface to add-on resource 474, to TPM 476, and to network interface 480. Peripheral interface 472 can be the same type of interface as I/O channel 412 or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral interface 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board, or add-in card disposed within information handling system 400, a device that is external to the information handling system, or a combination thereof.

Network interface 480 represents a network communication device disposed within information handling system 400, on a main circuit board of the information handling system, integrated onto another component such as chipset 410, in another suitable location, or a combination thereof. Network interface 480 includes a network channel 482 that provides an interface to devices that are external to information handling system 400. In a particular embodiment, network channel 482 is of a different type than peripheral interface 472 and network interface 480 translates information from a format suitable to the peripheral channel to a format suitable to external devices.

In a particular embodiment, network interface 480 includes a NIC or host bus adapter (HBA), and an example of network channel 482 includes an InfiniBand channel, a Fibre Channel, a Gigabit Ethernet channel, a proprietary channel architecture, or a combination thereof. In another embodiment, network interface 480 includes a wireless communication interface, and network channel 482 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 482 can be connected to an external network resource (not illustrated). The network resource can include another information handling system, a data storage system, another network, a grid management system, another suitable resource, or a combination thereof.

BMC 490 is connected to multiple elements of information handling system 400 via one or more management interface 492 to provide out of band monitoring, maintenance, and control of the elements of the information handling system. As such, BMC 490 represents a processing device different from processor 402 and processor 404, which provides various management functions for information handling system 400. For example, BMC 490 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 490 can vary considerably based on the type of information handling system. BMC 490 can operate in accordance with an Intelligent Platform Management Interface (IPMI). Examples of BMC 490 include an Integrated Dell® Remote Access Controller (iDRAC).

Management interface 492 represents one or more out-of-band communication interfaces between BMC 490 and the elements of information handling system 400, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 400, that is apart from the execution of code by processors 402 and 404 and procedures that are implemented on the information handling system in response to the executed code.

BMC 490 operates to monitor and maintain system firmware, such as code stored in BIOS/EFI module 442, option ROMs for graphics adapter 430, disk controller 450, add-on resource 474, network interface 480, or other elements of information handling system 400, as needed or desired. In particular, BMC 490 includes a network interface 494 that can be connected to a remote management system to receive firmware updates, as needed or desired. Here, BMC 490 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 490 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 490, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 490 is included on a main circuit board (such as a baseboard, a motherboard, or any combination thereof) of information handling system 400 or is integrated onto another element of the information handling system such as chipset 410, or another suitable element, as needed or desired. As such, BMC 490 can be part of an integrated circuit or a chipset within information handling system 400. An example of BMC 490 includes an iDRAC, or the like. BMC 490 may operate on a separate power plane from other resources in information handling system 400. Thus BMC 190 can communicate with the management system via network interface 494 while the resources of information handling system 400 are powered off. Here, information can be sent from the management system to BMC 190 and the information can be stored in a RAM or NVRAM associated with the BMC. Information stored in the RAM may be lost after power-down of the power plane for BMC 490, while information stored in the NVRAM may be saved through a power-down/power-up cycle of the power plane for the BMC.

Information handling system 400 can include additional components and additional busses, not shown for clarity. For example, information handling system 400 can include multiple processor cores, audio devices, and the like. While a particular arrangement of bus technologies and interconnections is illustrated for the purpose of example, one of skill will appreciate that the techniques disclosed herein are applicable to other system architectures. Information handling system 400 can include multiple central processing units (CPUs) and redundant bus controllers. One or more components can be integrated together. Information handling system 400 can include additional buses and bus protocols, for example, I²C and the like. Additional components of information handling system 400 can include one or more storage devices that can store machine-executable code, one or more communications ports for communicating with external devices, and various input and output (I/O) devices, such as a keyboard, a mouse, and a video display.

For purposes of this disclosure, information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 400 can include processing resources for executing machine-executable code, such as processor 402, a programmable logic array (PLA), an embedded device such as a System-on-a-Chip (SoC), or other control logic hardware. Information handling system 400 can also include one or more computer-readable media for storing machine-executable code, such as software or data.

The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

Although FIG. 3 shows example blocks of method 300 in some implementations, method 300 may include additional blocks, fewer blocks, different blocks, or differently arranged blocks than those depicted in FIG. 3. Those skilled in the art will understand that the principles presented herein may be implemented in any suitably arranged processing system. Additionally, or alternatively, two or more of the blocks of method 300 may be performed in parallel. For example, block 330 and block 335 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
storing, by a processor, data associated with an image to a frame buffer in response to detecting a signal to switch to a display mode;
reading the data associated with the image from the frame buffer after the storing the image subsequent to the detecting the signal;
providing the data associated with the image to a display panel for display during a transition to the display mode;
maintaining the image in the display panel until the transition to the display mode is complete; and
updating the image in the display panel with another image from video data associated with the display mode.

2. The method of claim 1, further comprising generating the signal in response to receiving a command to switch to the display mode.

3. The method of claim 1, wherein the signal is analog.

4. The method of claim 1, wherein the image is a last known image of video data currently displayed.

5. The method of claim 1, wherein the reading of the image from the frame buffer is initiated after the storing of the image in the frame buffer is finished.

6. The method of claim 1, wherein the frame buffer is included in a timing controller package.

7. The method of claim 1, wherein the frame buffer is included in a timing controller die.

8. The method of claim 1, further comprising reading display information associated with the display mode from an electronically erasable programmable read-only memory.

9. A display device, comprising:
a display panel;
a frame buffer; and
a timing controller configured to:
store data associated with an image to the frame buffer in response to detecting a signal to switch to a display mode;
read the data associated with the image from the frame buffer after the signal is detected;
provide the data associated with the image to the display panel;
maintain the image in the display panel until a transition to the display mode is complete; and
update the image in the display panel with another image from video data associated with the display mode.

10. The display device of claim 9, wherein the signal is generated in response to receipt of a command to switch to the display mode.

11. The display device of claim 9, wherein the signal is analog.

12. The display device of claim 9, wherein the image is a last known image of video data currently displayed.

13. The display device of claim 9, wherein the frame buffer is included in a timing controller package.

14. The display device of claim 9, wherein the frame buffer is included in a timing controller die.

15. A non-transitory computer-readable medium to store instructions that are executable to perform operations comprising:
storing data associated with an image to a frame buffer in response to detecting a signal to switch to a display mode;
reading the data associated with the image from the frame buffer after the storing the image after the detecting the signal;
providing the data associated with the image to a display panel for display during a transition to the display mode;
maintaining the image in the display panel until the transition to the display mode is complete; and
updating the image in the display panel with another image from video data associated with the display mode.

16. A non-transitory computer-readable medium of claim 15, wherein the operations further comprise generating the signal in response to receiving a command to switch to the display mode.

17. The non-transitory computer-readable medium of claim 15, wherein the signal is analog.

18. The non-transitory computer-readable medium of claim 15, wherein the image is a last known image of video data currently displayed.

19. The non-transitory computer-readable medium of claim 15, wherein the reading of the image from the frame buffer is initiated after the storing of the image to the frame buffer is finished.

20. The non-transitory computer-readable medium of claim 15, wherein the frame buffer is included in a timing controller package.
